(19) United States
(12) Patent Application Publication
(10) Pub. No.: US 2024/0140866 A1
(43) Pub. Date: May 2, 2024

(54) READY MIX COMPOSITION AND A PROCESS FOR ITS PREPARATION

(71) Applicant: Alok Giridhari KALE, Pune (IN)

(72) Inventors: Alok Giridhari KALE, Pune (IN); Akshay Prakash DEOKAR, Pune (IN)

(73) Assignee: Alok Giridhari KALE, Pune (IN)

(21) Appl. No.: 18/547,009

(22) PCT Filed: Feb. 21, 2022
(86) PCT No.: PCT/IB2022/051514

§ 371 Date: Aug. 18, 2023

(30) Foreign Application Priority Data
Feb. 19, 2021 (IN) 202121007084
Jul. 7, 2021 (IN) 202121030508

(51) Int. Cl. C04B 18/14; C04B 14/06; C04B 16/02; C04B 16/06; C04B 18/08; C04B 18/24; C04B 28/04; C04B 40/00; C04B 40/06

(52) U.S. Cl. CPC C04B 18/149; C04B 14/06; C04B 16/02; C04B 16/06; C04B 18/08; C04B 18/241; C04B 28/04; C04B 40/0032; C04B 40/0046; C04B 40/0608; C04B 2103/0054

(57) ABSTRACT

The present disclosure relates to a ready mix composition. The ready mix composition comprises a dry waste foundry sand, at least one binding agent, at least one polymer, and optionally at least one filler. The present disclosure further relates to a process for the preparation of a ready mix composition and a kit comprising the ready mix composition. The ready mix composition of the present disclosure does not require water for curing, has improved bond fixing time and trafficable time. The composition provides an improved appearance and is eco-friendly.

### FIELD

The present disclosure relates to a ready mix composition and a process for its preparation.

### Definitions

As used in the present disclosure, the following terms are generally intended to have the meaning as set forth below, except to the extent that the context in which they are used indicates otherwise.

Waste foundry sand (WFS)/Used foundry sand (UFS) refers to a discarded material coming from ferrous (iron and steel) and nonferrous (copper, aluminium, and brass) metal-casting industries.

M-sand (manufactured sand) refers to sand prepared by crushing hard granite. The m-sand has angular sand particles that are responsible for its strength and increase its water demand which can further be compensated by adding cement content.

Ready Mix refers to mortar composition, stucco, tile adhesive, plaster composition, block adhesive, and the like.

Stucco ordinarily refers to a type of plaster used for covering walls, ceilings, sculptural and artistic material in architecture, especially for the transformation into decorative patterns.

Stucco is normally applied in a wet state and solidifies to a dense solid. It can be applied to construction materials such as metal, concrete, cinder block, clay brick, tile, and the like.

Trafficable time refers to the time required for the surface to be ready for use.

Re-dispersible polymer powder (RDP) refers to a free-flowing powder obtained by spray drying of an aqueous vinyl acetate-ethylene copolymer dispersion.

Open time refers to the time from mixing the ready mix composition with a suitable quantity of water to the point at which the workable paste is no longer usable. It is also known as working time or usable life.

Pot life refers to the time period from mixing the ready-mix composition with a suitable quantity of water to the point at which the workable paste is no longer usable. It is also known as working time or usable life. Pot life is often considered as the length of time that a workable paste retains consistency enough to be applied to a surface.

Shear strength refers to the ability of the material to resist forces that cause the material's internal structure to slide against itself.

Tensile strength refers to the measurement of the force that can be applied to a material to break or stretch irreparably.

Flexural strength refers to the ability of the material to resist deformation under load.

Flexural strength indicates how much force is required to break a test sample of a defined diameter.

Compressive strength refers to the maximum stress of a material that can sustain without fracture.

Pull-off adhesion strength refers to the resistance of a material to separate from a substrate when a perpendicular tensile force is applied.

Binding agent (binder) refers to a substance that holds or draws other materials together mechanically, chemically, or as an adhesive, to form a cohesive unit.

Filler refers to a substance that is added to prepare necessary mass and reduce the usage of expensive materials.

Specific gravity or relative gravity refers to a ratio of the density of a substance to the density of the water at a specified temperature and at a specified pressure.

Portland Pozzolana Cement (PPC) refers to integrated cement which is formed by synthesizing OPC cement with pozzolanic materials in a certain proportion.

Fly ash refers to a fine grey powder consisting mostly of spherical, glassy particles that are produced as a byproduct in coal-fired power stations.

### BACKGROUND

The background information hereinbelow relates to the present disclosure but is not necessarily prior art.

Mortar is a commonly used material for joining bricks, stones, blocks, tiles, sheets, protective covering on walls and ceiling, to fill and seal irregular gaps between them and the like. Mortar typically comprises cement and sand, mixed with water in a certain ratio. Several mortar premixes are manufactured as a dry powder and mixed with water to form a workable paste just before it is applied to the surface.

The most common practice of use of mortar in the construction site involves on-site mixing of cement, sand, and water in a predefined ratio to prepare the mortar. The quality of such mortar depends on the raw materials used, their correct mixing ratio, the homogeneity of the mixture, the quality and the quantity of water used, and the consistency of the final mortar composition. However, the consistency of such on-site mixed mortars may vary due to errors that can occur during the mixing of the raw materials that affect the homogeneity of the final product which results in an inconsistent mortar mixture.

Sand is used extensively in the preparation of mortar composition. The demand for natural sand in the construction industry has increased a lot, resulting in stress on the availability of sand resources. Sand mining results in loss of land because of the river or coastal erosion and lowering of the water table. Huge volumes of sand are being extracted due to huge demand, which has a major impact on deltas, rivers, and marine ecosystems.

Casting is a mechanical process, that requires sand as a raw material containing about 95% silica. After the completion of the casting process, the waste sand from the casting contains 70% silica, which is generally discarded as a waste foundry sand. Disposal of this huge waste foundry sand is very difficult and often contains toxic heavy metals and particulate matters, which make dumping of the waste foundry sand an environmental and health hazard. These heavy metals may leach into the ground and mix with groundwater.

Conventionally, the ready mix compositions consist of cement and natural sand as the main ingredients. Moreover, the conventional ready mix compositions have high water demand, poor open time, less pot life, low shear strength, low tensile strength, poor bond fixing time, and poor trafficable time.

There is, therefore, felt a need to provide a ready mix composition that overcomes the above-mentioned drawbacks.

### OBJECTS

Some of the objects of the present disclosure, which at least one embodiment herein satisfies, are as follows:

It is an object of the present disclosure to ameliorate one or more problems of the prior art or to at least provide a useful alternative.

Another object of the present disclosure is to provide a ready mix composition for various construction purposes.

Yet another object of the present disclosure is to provide a ready mix composition that is ready to use.

Another object of the present disclosure is to provide a ready mix composition with increased bond fixing time and trafficable time.

Yet another object of the present disclosure is to provide a ready mix composition with increased tensile strength, shear strength and has a longer pot life.

Still another object of the present disclosure is to provide a process for the preparation of a ready mix composition.

Other objects and advantages of the present disclosure will be more apparent from the following description, which is not intended to limit the scope of the present disclosure.

### SUMMARY

The present disclosure relates to a ready mix composition and a process for its preparation. In an aspect, the ready mix composition comprises dry waste foundry sand in an amount in the range of 20 mass % to 90 mass % with respect to the total mass of the composition; at least one binding agent in an amount in the range of 10 mass % to 40 mass % with respect to the total mass of the composition; at least one polymer in an amount in the range of 0.1 mass % to 3 mass % with respect to the total mass of the composition; and optionally at least one filler in an amount in the range of 2 mass % to 60 mass % with respect to the total mass of the composition.

In another aspect, the process for the preparation of a ready mix composition comprises drying a predetermined amount of waste foundry sand at a predetermined temperature for a predetermined time period to obtain a dry waste foundry sand. The dry waste foundry sand is mixed with at least one binding agent, optionally at least one filler to obtain a mixture. To the mixture, a predetermined amount of polymer is added to obtain the ready mix composition.

The present disclosure still further provides a kit comprising a ready mix composition, and water wherein the composition is mixed with a predetermined amount of water before use.

### DETAILED DESCRIPTION

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The most common practice ready mix in the construction site involves on-site mixing of cement, sand, and water in a predefined ratio to prepare the mortar. The quality of such mortar depends on the raw materials used, their correct mixing ratio, the homogeneity of the mixture, the quality and the quantity of water used, and the consistency of the final mortar composition. However, the consistency of such on-site mixed mortars may vary due to errors that can occur during the mixing of the raw materials that affect the homogeneity of the final product which results in an inconsistent mortar mixture.

The conventional ready mix compositions consist of cement and natural sand as the main ingredients. Moreover, the conventional ready mix compositions have high water demand, poor open time, less pot life, low shear strength, low tensile strength, poor bond fixing time, and poor trafficable time.

The present disclosure provides a ready mix composition that is economical, environment friendly with improved physical properties.

In an aspect of the present disclosure, there is provided a ready mix composition.

In accordance with the present disclosure, the ready mix composition comprises dry waste foundry sand in an amount in the range of 20 mass % to 90 mass % with respect to the total mass of the composition; at least one binding agent in an amount in the range of 10 mass % to 40 mass % with respect to the total mass of the composition; at least one polymer in an amount in the range of 0.1 mass % to 3 mass % with respect to the total mass of the composition; and optionally at least one filler in an amount in the range of 2 mass % to 50 mass % with respect to the total mass of the composition.

In an embodiment, the dry waste foundry sand is characterized by having:
a. a grain shape selected from subangular, subangular, very angular, rounded, sub-rounded, and well rounded;
b. specific gravity in the range of 1.9 to 2.5;
c. fineness modulus in the range of 2.3 to 2.5;
d. moisture content in the range of 0.1% to 6%;
e. fineness number in the range of 40 to 70 AFS;
f. pH in the range of 4 to 10;
g. clay lumps and friable particles in the range of 40 to 70 AFS;
h. bentonite clay in an amount in the range of 7 to 15%;
i. lustrous coal in an amount in the range of 2 to 7%;
j. iron particles in an amount in the range of 0.05 to 0.2%;
k. silica content in an amount in the range of 70 to 90%;
l. aluminium oxide in an amount in the range of 2.5% to 5%;
m. mean particle size (d90) is in the range of 0.1 mm to 1 mm; and
n. mean particle size (d10) is in the range of 0.01 mm to 0.1 mm.

In an embodiment, the particle size of the dry waste foundry sand is in the range of 0.01 mm to 1.5 mm. In another embodiment, the particle size of the dry waste foundry sand is in the range of 0.075 mm to 0.6 mm. In an exemplary embodiment, the particle size of the dry waster foundry sand is 0.3 mm. In another exemplary embodiment, the particle size of the dry waste foundry sand is 0.4 mm.

In accordance with the embodiments of the present disclosure, the binding agent is selected from the group consisting of Portland Pozzolana Cement (PPC), Ordinary Portland Cement (OPC), Portland Slag Cement (PSC), low heat cement, hydrophobic port land cement, rapid hardening cement, extra rapid hardening cement, sulphate resisting cement, quick setting cement, blast furnace slag cement, high alumina cement, white cement, and ethyl cellulosic compounds. In an exemplary embodiment of the present disclosure, the binding agent is Ordinary Portland Cement (OPC).

In an embodiment, the binding agent is in the range of 10 mass % to 40 mass % with respect to the total mass of the composition.

In an embodiment, the mass ratio of the dry waste foundry sand to the binding agent is in the range of 1:0.15 to 1:0.7.

In accordance with the embodiments of the present disclosure, the polymer is selected from the group consisting of re-dispersible polymer powder (RDP), methyl hydroxyethyl cellulose powder, cellulose fibers, recron fibers, and natural fibers.

In an embodiment, the RDP is selected from vinyl acetate-ethylene copolymer powder, styrene-acrylic copolymer, vinyl ester of versatic acid copolymer.

The re-dispersible polymer powder is a free-flowing white powder obtained by spray drying of polymer/copolymer dispersion. The re-dispersible polymer powder, upon mixing with water, forms a liquid emulsion with essentially identical properties. The polymer powder provides improved adhesion, flexural strength, deformability, abrasion resistance to the ready mix composition.

In accordance with the embodiment of the present disclosure, the cellulose fibers are selected from the group consisting of jute fibers, coconut fibers, hemp fibers, fibers derived from the paper/board/recycled paper, wool fibers, cotton fibers, rock wool fibers, and lignocellulose fibers.

In accordance with an embodiment of the present disclosure, the amount of the polymer is in the range of 0.1 mass % to 3 mass % with respect to the total mass of the composition.

In accordance with the embodiments of the present disclosure, the filler is at least one selected from the group consisting of fly ash, bottom ash, pond ash, volcanic ash, agro-waste ash, yellow sand, plaster sand, regular silica sand, crush sand, manufactured sand (m-sand), slag sand, concrete sand, aggregate chips, and pit sand. In an exemplary embodiment, the filler is fly ash. In another exemplary embodiment of the present disclosure, the filler is crush sand. In still another exemplary embodiment of the present disclosure, the filler is plaster sand. In yet another exemplary embodiment of the present disclosure, the filler is aggregate chips.

In accordance with an embodiment of the present disclosure, the amount of the filler is in the range of 2 mass % to 60 mass % with respect to the total mass of the composition.

In accordance with the embodiments of the present disclosure, the filler consists of an anti-caking agent. Typically, the amount of the anti-caking agent is in the range of 0.1 mass % to 10 mass % with respect to the total mass of the composition.

In accordance with the embodiments of the present disclosure, the anti-caking agent is selected from the group consisting of magnesium carbonate, calcium carbonate, nano silicon, rubber powder, silica fume, micro silica, mineral fibers, and magnesium stearate.

In an embodiment, the ready mix composition provides a compressive strength in the range of 5 N/mm² to 20 N/mm².

In an embodiment, the trafficable time of the ready mix composition of the present disclosure is 24 hours.

In an embodiment, the pot life of the ready mix composition of the present disclosure is in the range of 100 minutes to 360 minutes. The pot life of the ready mix composition is directly proportional to the amount of dry waste foundry sand and the binding agent in the composition.

In an embodiment, the open time of the ready mix composition of the present disclosure is in the range of 40 minutes to 70 minutes. The open time of the ready mix composition is directly proportional to the dry waste foundry sand content in the composition.

The shelf life of the ready mix composition in accordance with the present disclosure is in the range of 4 months to 12 months in a dry environment. Typically, the ready mix composition has a moisture content of less than 3%. The lower the moisture content, the longer will be the shelf life.

The ready mix composition of the present disclosure is used for fixing the tiles, blocks, vitrified tiles, ceramics, porcelain, 3D printed structure, plastering, and stoneware.

In an embodiment, the ready mix composition is in a form selected from the group consisting of tile adhesive, ready mix plaster, and block adhesive.

In an embodiment, the amount of the ingredients of ready mix composition varies based on the end application. The tile adhesive can have dry waste foundry sand up to 80 mass %, whereas the ready mix plaster the content doesn't exceed 60 mass %.

In accordance with an embodiment of the present disclosure, the ready mix composition in the form of a tile adhesive composition that comprises dry waste foundry sand in an amount in the range of 45 mass % to 80 mass % with respect to the total mass of the composition; at least one binding agent in an amount in the range of 15 mass % to 30 mass % with respect to the total mass of the composition; at least one polymer in an amount in the range of 0.5 mass % to 2 mass % with respect to the total mass of the composition; and optionally at least one filler in an amount in the range of 5 mass % to 20 mass % with respect to the total mass of the composition.

In an embodiment, the tile adhesive composition is mixed with water in an amount in the range of 15 mass % to 22 mass % with respect to the total mass of the tile adhesive composition, before use.

In accordance with an embodiment of the present disclosure, the ready mix composition in the form of a ready mix plaster composition that comprises dry waste foundry sand in an amount in the range of 25 mass % to 35 mass % with respect to the total mass of the composition; at least one binding agent in an amount in the range of 15 mass % to 30 mass % with respect to the total mass of the composition; at least one polymer in an amount in the range of 0 mass % to 3 mass % with respect to the total mass of the composition; at least one filler in an amount in the range of 45 mass % to 65 mass % with respect to the total mass of the composition.

In an embodiment, the ready mix plaster composition is mixed with water in an amount in the range of 15 mass % to 22 mass % with respect to the total mass of ready mix plaster before use.

In accordance with an embodiment of the present disclosure, the ready mix composition in the form of a block adhesive comprises a dry waste foundry sand in an amount in the range of 45 mass % to 65 mass % with respect to the total mass of the composition; at least one binding agent in an amount in the range of 15 mass % to 30 mass % with respect to the total mass of the composition; at least one polymer in an amount in the range of 0.2 mass % to 1.5 mass % with respect to the total mass of the composition; and optionally at least one filler in an amount in the range of 15 mass % to 25 mass % with respect to the total mass of the composition.

In an embodiment, the ready mix composition in the form of block adhesive is mixed with water in an amount in the range of 15 mass % to 22 mass % with respect to the total mass of block adhesive, before use.

In another aspect of the present disclosure, there is provided a process for the preparation of a ready mix composition. The process is described in detail.

In a first step, a predetermined amount of the waste foundry sand is dried at a predetermined temperature for a predetermined time period to obtain a dry waste foundry sand.

In an embodiment, the predetermined temperature is in the range of 80° C. to 100° C. In an exemplary embodiment, the temperature is 90° C.

In an embodiment, the predetermined time period is in the range of 2 minutes to 15 minutes. In an exemplary embodiment, the time period is 10 minutes.

In an embodiment, the moisture content in the dry waste foundry sand is in the range of 0.1% to 6%.

In a second step, predetermined amounts of the dry waste foundry sand, at least one binding agent, and optionally at least one filler are mixed to obtain a mixture.

In accordance with the embodiments of the present disclosure, the binding agent is selected from the group consisting of Portland Pozzolana Cement (PPC), Ordinary Portland Cement (OPC), Portland Slag Cement (PSC), low heat cement, hydrophobic portland cement, rapid hardening cement, extra rapid hardening cement, sulphate resisting cement, quick-setting cement, blast furnace slag cement, high alumina cement, white cement, and ethyl cellulosic compounds. In an exemplary embodiment of the present disclosure, the binding agent is Ordinary Portland Cement (OPC).

In an embodiment, the binding agent is in the range of 10 mass % to 40 mass % with respect to the total mass of the composition.

In accordance with the embodiments of the present disclosure, the filler is at least one selected from the group consisting of fly ash, bottom ash, pond ash, volcanic ash, agro-waste ash, yellow sand, plaster sand, regular silica sand, crush sand, manufactured sand (m-sand), slag sand, concrete sand, aggregate chips, and pit sand. In an exemplary embodiment, the filler is fly ash. In another exemplary embodiment of the present disclosure, the filler is crush sand. In still another exemplary embodiment of the present disclosure, the filler is plaster sand. In yet another exemplary embodiment of the present disclosure, the filler is aggregate chips.

In accordance with an embodiment of the present disclosure, the amount of the filler is in the range of 2 mass % to 60 mass % with respect to the total mass of the composition.

In accordance with the embodiments of the present disclosure, the filler includes an anti-caking agent. Typically, the amount of the anti-caking agent is in the range of 0.1 mass % to 10 mass % with respect to the total mass of the composition.

In accordance with the embodiments of the present disclosure, the anti-caking agent is selected from the group consisting of magnesium carbonate, calcium carbonate, nano silicon, rubber powder, silica fume, micro silica, mineral fibers, and magnesium stearate.

In a third step, a predetermined amount of polymer is added to the mixture to obtain the ready mix composition.

In accordance with the embodiments of the present disclosure, the polymer is selected from the group consisting of re-dispersible polymer powder (RDP), methyl hydroxyethyl cellulose powder, cellulose fibers, recron fibers, and natural fibers.

In an embodiment, the RDP is selected from vinyl acetate-ethylene copolymer powder, styrene-acrylic copolymer, and vinyl ester of versatic acid copolymer.

The re-dispersible polymer powder is a free-flowing white powder obtained by spray drying of polymer/copolymer dispersion. The re-dispersible polymer powder, upon mixing with water, forms a liquid emulsion with essentially identical properties. The polymer powder provides improved adhesion, flexural strength, deformability, abrasion resistance to the ready mix composition.

In accordance with the embodiment of the present disclosure, the cellulose fibers are selected from the group consisting of jute fibers, coconut fibers, hemp fibers, fibers derived from the paper/board/recycled paper, wool fibers, cotton fibers, rock wool fibers, and lignocellulose fibers.

In accordance with an embodiment of the present disclosure, the amount of the polymer is in the range of 0.1 mass % to 3 mass % with respect to the total mass of the composition.

In an embodiment, a predetermined amount of water is blended with the ready mix composition for a time period in the range of 3 min to 10 min before use.

In an embodiment, the predetermined amount of water is in the range of 15 mass % to 22 mass % with respect to the total mass of ready mix composition.

In an embodiment, the blending speed is in the range of 50 rpm to 100 rpm.

In another aspect of the present disclosure, there is provided a kit comprising the ready mix composition and water.

In an embodiment, the kit comprises a predetermined amount of dry waste foundry sand, a predetermined amount of at least one binding agent, a predetermined amount of at least one polymer, and optionally a predetermined amount of at least one filler, which is mixed with a predetermined amount of water before use.

In an embodiment, the predetermined amount of water is in the range of 15 mass % to 22 mass % with respect to the total mass of ready mix composition before use.

The foregoing description of the embodiments has been provided for purposes of illustration and is not intended to limit the scope of the present disclosure. Individual components of a particular embodiment are generally not limited to that particular embodiment but are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be tested to scale up to industrial/commercial scale and the results obtained can be extrapolated to the industrial scale.

### EXPERIMENTAL DETAILS

### Experiment I: Preparation of Ready Mix Composition in Accordance with the Present Disclosure

### Example 1

100 kg of waste foundry sand (WFS) (particle size 0.3 mm) having a moisture content of 2% was heated at 90° C. for 30 minutes to obtain the dry waste foundry sand. The moisture content of the dry waste foundry sand was 0.5%.

### Example 2

12 kg of dry waste foundry sand (WFS) (particle size 0.3 mm), 6.8 kg of ordinary portland cement (OPC), and 2.0 kg of fly ash and 6.0 kg of crushed sand of 2.36 mm to 1.18 mm and 12.5 kg of plaster sand of 1.18 mm to 0.6 mm were charged to the blender to obtain a mixture. To the mixture, 700 gm of recron fiber was blended to obtain the ready mix composition (stucco composition).

### Example 3

13 kg of dry waste foundry sand (WFS), 7 kg of ordinary portland cement (OPC), and 2 kg of fly ash, 7.1 kg of crushed sand of 2.36 mm to 1.18 mm, and 10.1 kg of plaster sand of size 1.18 mm to 0.6 mm were charged to the blender to obtain a mixture. To the mixture, 900 gm of recron fiber was blended to obtain the ready mix composition (stucco composition).

### Example 4

12 kg of dry waste foundry sand (WFS), 7 kg of ordinary portland cement (OPC), 2 kg of fly ash, and 19 kg of plaster sand size 1.18 mm to 0.6 mm were charged to the blender to obtain ready mix composition (stucco composition).

### Example 5

15 kg of dry waste foundry sand (WFS), 3.18 kg of ordinary portland cement (OPC), 1.5 kg of fly ash, were charged to the blender to obtain a mixture. To the mixture, 0.54 kg polymer (RDP, MHEC, fibers derived from the paper in equal proportion) was blended to obtain the ready mix composition (tile adhesive).

### Example 6

10 kg of dry waste foundry sand (WFS), 5.68 kg of ordinary portland cement (OPC), and 4 kg of fly ash were charged to the blender to obtain a mixture. To the mixture, 0.54 kg polymer (RDP, MHEC, fibers derived from the paper in equal proportion) was blended to obtain the ready mix composition (tile adhesive).

### Example 7

26 kg of dry waste foundry sand (WFS), 7.2 kg of ordinary portland cement (OPC), and 6.3 kg of fly ash were charged to the blender to obtain a mixture. To the mixture, 0.5 kg polymer (RDP, MHEC) was blended to obtain the ready mix composition (block adhesive).

### Example 8

20 kg of dry waste foundry sand (WFS), 11.46 kg of ordinary portland cement (OPC), 7.4 kg of fly ash were charged to the blender to obtain a mixture. To the mixture, 0.5 kg polymer (RDP, MHEC) was blended to obtain the ready mix composition (block adhesive).

### Experiment II: Study/Analysis of Ready Mix Composition

### Example 9

The properties of the ready mix composition of the present disclosure were determined according to IS and ASTM. The samples were evaluated for pot life, open time, shear strength, tensile strength, compressive strength, and pull-off adhesion strength tensile strength. The results are provided in table 1 and 2 below,

TABLE 1

| S. No | Parameters | Standard | Example 1 | | Example 2 | | Example 3 | |
|---|---|---|---|---|---|---|---|---|
| 1 | Tensile adhesion | IS5477-2019 | 0.5 | N/mm² | 1.0 | N/mm² | 1.5 | N/mm² |
| | strength - dry | | | | | | | |
| | condition | | | | | | | |
| 2 | Tensile adhesion | IS5477-2019 | NA | | 1.0 | N/mm² | 1.0 | N/mm² |
| | strength - wet | | | | | | | |
| | condition | | | | | | | |
| 3 | Shear adhesion | IS5477-2019 | 1.0 | N/mm² | 1.25 | N/mm² | 1.5 | N/mm² |
| | strength - dry | | | | | | | |
| | condition | | | | | | | |
| 4 | Shear adhesion | IS5477-2019 | NA | | 1.0 | N/mm² | 1.0 | N/mm² |
| | strength - heat | | | | | | | |
| | aging | | | | | | | |
| 5 | Shear adhesion | IS5477-2019 | NA | | 1.0 | N/mm² | 1.0 | N/mm² |
| | strength - wet | | | | | | | |
| | condition | | | | | | | |
| 6 | Pot life | IS5477-2004 | 410 | min | 300 | min | 250 | min |
| 7 | Open time | IS5477-2004 | 60 | min | 50 | min | 50 | min |
| 8 | Trafficable time | NA | 24 | hr | 24 | hr | 24 | hr |

It is evident from the above table that the composition of the present disclosure has enhanced pot life, open time, tile adhesion strength (dry and wet condition) and shear adhesion strength (dry and wet condition).

TABLE 2

| | | | Example 5 | | Example 7 | |
|---|---|---|---|---|---|---|
| Sl. | | | (Tile | | (Block | |
| No. | Parameters | Standard | adhesive) | | adhesive) | |
| 1 | Flexural strength | ASTM C | 2.98 | MPa | NA | |
| | (28 days) | 348 | | | | |
| 2 | Compressive | ASTM C | 18 | MPa | 7.83 | MPa |
| | strength (28 days) | 109 | | | | |
| 3 | Pull off adhesion | ASTM D | 0.51 | MPa | 0.54 | |
| | strength | 4541 | | | | |
| 4 | Loose bulk | | 1482 | Kg/m³ | 1248 | Kg/m³ |
| | density | | | | | |

| | | | | | |
|---|---|---|---|---|---|
| 5 | Initial setting time | IS 4031 | 3 | hr | 4 hr 55 min |

(Part 5)

| | | | | | |
|---|---|---|---|---|---|
| 6 | Final setting time | IS 4031 | 5 | hrs | 5 hr 55 min |

(Part 5)

It is evident from the above table that the composition of the present disclosure has enhanced flexural strength, compressive strength, pull off adhesion strength, and initial setting time.

### Example 10

The properties of the tile adhesive composition of the present disclosure were compared with the commercially available tile adhesives. The results are illustrated in Table 3 below:

TABLE 3

| | | | Tile adhesive | | | | | | | |
|---|---|---|---|---|---|---|---|---|---|---|
| | | | composition | | | | | | | |
| | | | of the present | | Saint Gobain | | Ascolite Fix | | MYK Laticrete | |
| S. | | IS 15477- | disclosure | | Weber Nova | | Bond + | | XTRABOND | |
| No | Parameters | 2004 | (Example 4) | | Type 2 | | Type 2 | | FSA 336 Type 2 | |
| 1 | Water Demand | — | 22% | | 26 to 28% | | 25 to 26% | | 25 to 26% | |
| 2 | Open time | — | 50 | min | 30 | min | 30 | min | 20 | min |
| 3 | Adjustability | — | 40 | min | 15 | min | 15 | min | 30 | min |
| 4 | Pot life | | 300 | min | 180 | min | 60 | min | 50 | min |
| 5 | Shear strength | 10.00 KN | 9.57 | KN | 11.1 | KN | 10.5 | KN | 10.5 KN = | |
| | dry (14 days) | | | | | | | | 11.5 KN | |
| 6 | Shear strength | 5.00 KN | 7.04 | KN | 5.57 | KN | 5.50 | KN | 5.50 KN- | |
| | wet (7 + 7 days) | | | | | | | | 6.50 KN | |
| 7 | Shear strength | 5.00 KN | 8.10 | KN | 5.54 | KN | 5.15 | KN | 5.50 KN- | |
| | heat aging (7 + 7 | | | | | | | | 6.50 KN | |
| | days) | | | | | | | | | |
| 8 | Tensile strength | | 1.407 | KN | 0.97 | KN | 0.90 | KN | 0.70-1.00 | KN |
| | dry (14 days) | | | | | | | | | |
| 9 | Coverage | | 2-3 | sqm | 2-3 | sqm | 2-3 | sqm | 2-3 | sqm |

It is evident from the above table that the tile adhesive of the present disclosure has enhanced pot life, shear strength, tensile strength, and open time when compared with commercially available products.

### Example 11

The properties of the ready mix composition of the present disclosure were compared with the commercially available ready mix plaster. The results are illustrated in Table 4 below:

TABLE 4

| | | | | Everplast Ready | | MAPEI Ready | |
|---|---|---|---|---|---|---|---|
| S. No | Parameters | Example 1 | | mix plaster | | mix plaster | |
| 1 | Water Demand | 15% | | 17 to 19% | | 25 to 26% | |
| 2 | Setting time | 10 | hrs | 12 | hr | 15 | hr |
| 3 | Flow | 113% | | — | | — | |
| 4 | Pot life | 120 | min | 60 to 120 | min | 60 to 120 | min |
| 5 | Loose bulk density | 1482 | Kg/m | 1400-1700 | Kg/m³ | 1500 | Kg/m³ |
| 6 | Compressive strength | 18.62 | MPa | ≥5 | N/mm³ | ≥5 | N/mm³ |

| | | | | | |
|---|---|---|---|---|---|
| 7 | Pull out adhesion | 0.51 | MPa | — | — |

| | | | | |
|---|---|---|---|---|
| 9 | Coverage | 16-17/sqft @ 10 | 16-17/sqft @ 10 | 16-17/sqft @ 10 |
| | | to 20 mm | to 20 mm | to 20 mm |

It is evident from the above table that the ready mix plaster composition of the present disclosure has enhanced compressive strength, and pull-out adhesion when compared with the commercially available products.

### Example 12

The properties of the block adhesive of the present disclosure were compared with the commercially available block adhesive. The results are illustrated in Table 5 below:

TABLE 5

| | | | | Magicrete | | Ecorex | | Ascolite | |
|---|---|---|---|---|---|---|---|---|---|
| S. No | Parameters | Example 6 | | Jointinig Mortar | | Jointing Mortar | | Jointinig Mortar | |
| 1 | Water Demand | 23.7% | | 17 to 19% | | 25 to 26% | | | |
| 2 | Flow | 66% | | — | | — | | | |
| 3 | Pot life | 390 | min | 120 | min | 30 | min | 30 | min |
| 4 | Loose bulk density | 1248 | Kg/m³ | 1600-1700 | Kg/m³ | 1650-1700 | Kg/m³ | 1650-1750 | Kg/m³ |
| 5 | Compressive strength | 6.48 | N/mm³ | ≥5 | N/mm³ | ≥5 | N/mm³ | >5 | N/mm³ |
| 6 | Split tensile strength | 0.44 | N/mm³ | ≥0.34 | N/mm³ | ≥0.34 | N/mm³ | >0.34 | N/mm³ |
| 7 | Wet Density | 1632 | N/mm³ | | | | | | |
| 8 | Coverage | 80-90 | sqft | 70-80 | sqft | 65-70 | sqft | 60-80 | sqft |

It is evident from the above table that the block adhesive of the present disclosure has enhanced pot life, compressive strength, and split tensile strength when compared with the commercially available products.

### TECHNICAL ADVANCEMENTS

The present disclosure described hereinabove has several technical advantages including, but not limited to, the realization of a ready mix composition that has improved bond fixing time;
has improved trafficable time;
is time-saving;
provides improved appearance;
reduces sand mining from river beds; and
is eco-friendly and economic due to the use of waste foundry sand.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

Throughout this specification the word “comprise”, or variations such as “comprises” or “comprising”, will be understood to imply the inclusion of a stated element, integer or step,” or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the invention to achieve one or more of the desired objects or results. While certain embodiments of the inventions have been described, these embodiments have been presented by way of example only, and are not intended to limit the scope of the inventions. Variations or modifications to the formulation of this invention, within the scope of the invention, may occur to those skilled in the art upon reviewing the disclosure herein. Such variations or modifications are well within the spirit of this invention.

The numerical values given for various physical parameters, dimensions and quantities are only approximate values and it is envisaged that the values higher than the numerical value assigned to the physical parameters, dimensions and quantities fall within the scope of the invention unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A ready mix composition comprising:
a. dry waste foundry sand in an amount in the range of 20 mass % to 90 mass % with respect to the total mass of the composition;
b. at least one binding agent in an amount in the range of 10 mass % to 40 mass % with respect to the total mass of the composition;
c. at least one polymer in an amount in the range of 0.1 mass % to 3 mass % with respect to the total mass of the composition; and
d. optionally at least one filler in an amount in the range of 5 mass % to 60 mass % with respect to the total mass of the composition.

2. The composition as claimed in claim 1, wherein said dry waste foundry sand comprises:
a. a grain shape selected from angular, subangular, very angular, rounded, sub rounded, and well rounded;
b. a specific gravity in the range of 1.9 to 2.5;
c. a fineness modulus in the range of 2.3 to 2.5;
d. a moisture content in the range of 0.1% to 6%;
e. a fineness number in the range of 40 to 70 AFS;
f. a pH in the range of 4 to 10;
g. clay lumps and friable particles in the range of 40 to 70 AFS;
h. bentonite clay in an amount in the range of 7 to 15%;
i. lustrous coal in an amount in the range of 2 to 7%;
j. iron particles in an amount in the range of 0.05 to 0.4%;
k. silica in an amount in the range of 70% to 90%;
l. aluminium oxide in an amount in the range of 2.5% to 5%;
m. a mean particle size (d90) in the range of 0.1 mm to 1 mm; and
n. a mean particle size (d10) in the range of 0.01 mm to 0.1 mm.

3. The composition as claimed in claim 1, wherein the particle size of said dry waste foundry sand is in the range of 0.01 mm to 1.5 mm.

4. The composition as claimed in claim 1, wherein said binding agent comprises one of Portland Pozzolana Cement (PPC), Ordinary Portland Cement (OPC), Portland Slag Cement (PSC), low heat cement, hydrophobic portland cement, rapid hardening cement, extra rapid hardening cement, sulphate resisting cement, quick-setting cement, blast furnace slag cement, high alumina cement, white cement, ethyl cellulosic compounds, and combinations thereof.

5. The composition as claimed in claim 1, wherein said polymer comprises one of re-dispersible polymer powder (RDP), methyl hydroxyethyl cellulose powder (MHEC), cellulose fibers, recron fibers, natural fibers, and combinations thereof.

6. The composition as claimed in claim 5, wherein said re-dispersible polymer powder (RDP) is selected from vinyl acetate-ethylene copolymer powder, styrene-acrylic copolymer, and vinyl ester of versatic acid copolymer.

7. The composition as claimed in claim 5, wherein said cellulose fibers comprise one of jute fibers, coconut fibers, hemp fibers, fibers derived from paper, board, and recycled paper, wool fibers, cotton fibers, rock wool fibers, lignocellulose fibers, and combinations thereof.

8. The composition as claimed in claim 1, wherein said filler is at least one of fly ash, bottom ash, pond ash, volcanic ash, agro-waste ash, yellow sand, plaster sand, regular silica sand, crush sand, manufactured sand (m-sand), slag sand, concrete sand, aggregate chips, and pit sand.

9. The composition as claimed in claim 1, wherein said filler comprises at least one anti caking agent in an amount in the range of 0.1 mass % to 10 mass % with respect to the total mass of the composition.

10. The composition as claimed in claim 9, wherein said anti-caking agent comprises one of magnesium carbonate, calcium carbonate, nano silicon, rubber powder, silica fume, micro silica, mineral fibers, magnesium stearate, and combinations thereof.

11. The composition as claimed in claim 1, wherein a mass ratio of said dry waste foundry sand to said binding agent is in the range of 1:0.15 to 1:0.7.

12. The composition as claimed in claim 1, wherein said composition has:
a. compressive strength in the range of 5 N/mm 2 to 20 N/mm 2; and
b. a shelf life in the range of 4 months to 12 months.

13. The composition as claimed in claim 1, wherein said composition is in a form of one of tile adhesive, ready mix plaster, and block adhesive.

14. A process for the preparation of a ready mix composition, said process comprising the following steps:
a. drying waste foundry sand at a predetermined temperature for a predetermined time period to obtain a dry waste foundry sand;
b. mixing said dry waste foundry sand, at least one binding agent, and optionally at least one filler to obtain a mixture; and
c. blending a predetermined amount of polymer to said mixture to obtain a ready mix composition;
wherein said ready mix composition is mixed with a predetermined amount of water before use.

15. The process as claimed in claim 14, wherein said predetermined temperature is in the range of 80° C. to 100° C.

16. The process as claimed in claim 14, wherein said predetermined time period is in the range of 2 minutes to 15 minutes.

17. The process as claimed in claim 14, wherein a moisture content in said dry waste foundry sand is in the range of 0.1% to 6%.

18. The process as claimed in claim 14, wherein said predetermined amount of water is in the range of 15 mass % to 22 mass % with respect to the total mass of ready mix composition.

19. (canceled)

20. (canceled)

21. The composition as claimed in claim 1, wherein said composition comprises
a. said dry waste foundry sand in an amount of 30 mass % with respect to the total mass of the composition;
b. said at least one binding agent in an amount of 17 mass % with respect to the total mass of the composition;
c. said at least one polymer in an amount of 2 mass % with respect to the total mass of the composition; and
d. said at least one filler in an amount of 51 mass % with respect to the total mass of the composition.

22. The composition as claimed in claim 1, wherein said composition comprises
a. said dry waste foundry sand in an amount of 50 mass % with respect to the total mass of the composition;
b. said at least one binding agent in an amount of 30 mass % with respect to the total mass of the composition;
c. said at least one polymer in an amount of 1.5 mass % with respect to the total mass of the composition; and
d. said at least one filler in an amount of 18.5 mass % with respect to the total mass of the composition.
